(19) United States
(12) Patent Application Publication
(10) Pub. No.: US 2010/0090899 A1
(43) Pub. Date: Apr. 15, 2010

(54) METHOD AND SYSTEM FOR POSITIONING OBJECT WITH ADAPTIVE RESOLUTION

(75) Inventors: Junhui ZHAO, Beijing (CN); Yongcai WANG, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/567,572

(22) Filed: Sep. 25, 2009

(30) Foreign Application Priority Data
Oct. 9, 2008 (CN) 200810161869.9

(51) Int. Cl. G01S 5/02; G01S 3/80; G01S 1/24

(52) U.S. Cl. 342/387; 342/463; 367/118

(57) ABSTRACT

The present invention provides a method and system for positioning an object with adaptive resolution. The method comprises: dividing a space to be detected into Hot Area and General Area; arranging, according to the positions of Hot Area and General Area, high-resolution positioning signal (US) transceivers and low-resolution positioning signal (RF) transceivers, wherein the detection scope of the low-resolution positioning signal transceivers covers the space and the detection scope of the high-resolution positioning signal transceivers covers the Hot Area; and when the object moving in the space, fusing the detection results from the high-resolution positioning signal transceivers and the low-resolution positioning signal transceivers to determine the position of the object with adaptive resolution. With the system of the present invention, for different areas, the object can be positioned with different positioning resolutions (precisions or granularities). Also, since it is not necessary to use a great deal of high-precision positioning devices, the system cost can be reduced considerably.

### FIELD OF THE INVENTION

The present invention is generally related to a positioning system and position sensing. More specifically, the present invention relates to a hybrid positioning method and system for combining high-precision positioning technology, e.g. ultrasound (US) positioning, with low-precision positioning technology, e.g. radio frequency (RF) positioning to provide adaptive positioning resolution for location-based services.

### BACKGROUND

Undoubtedly, location information is a fundamental context to be utilized to extract the geographical relationship between the users and the environments to further understand the user behaviors. The importance and promise of location-aware applications has led to the design and implementation of systems for providing location information, particularly in indoor and urban environments. Currently, there is an increasing market need for accurately tracking of people and assets in real time, in many different application scenarios including office, healthcare, coalmine, subway, smart building, restaurant etc. For instance, in office environment, employees are required to access confidential information database in certain secure zone. Out of the secure zone, any access will be prohibited. The examples of the secure zone can be a single room, part of working area, and even a table.

So far, many positioning systems have been developed to provide location-based services. However, there are some common limitations to the existing positioning systems.

Firstly, from technology perspective, most of positioning system focuses on utilizing a single type positioning device, either US-based or RF-based device for object locating. In fact, each signal type has its own advantages but some shortcomings. For example, US-based localization can achieve high accuracy but small scale, and on the other hand, RF-based approach provides large scale but low accuracy.

Secondly, from application perspective, for example, location-based access control, it is usually the case that people may require different positioning resolutions at different regions. At the interested area, fine-grained positioning granularity is needed so as to make sure that the positioning results in this area are highly accurate. At the other areas, a coarser-grained positioning granularity may be acceptable.

Below will give a brief introduction of the existing popular technologies for indoor positioning. The first point to be noted here is that Global Positioning System (GPS) can provide the object's location information with the accuracy of several ten meters outdoors, however, in indoor environment GPS does not work well since the positioning result of GPS degrades dramatically by multi-path effect and signal obstruction.

In general, there are three technologies commonly used for indoor positioning systems, i.e. ultrasound (US) positioning, radio frequency (RF) positioning and infrared positioning.

For example, in “Bat” system of U.S. Pat. No. 6,493,649 to Jones entitled “Detection system for determining positional and other information about objects”, the user can wear a small badge containing a US transmitter, which emits an ultrasonic pulse when radio-triggered by a central system. The diagram of the “Bat” system is for example shown in FIG. 1A. There are an array of dense US receivers installed on the ceiling of the space to be detected. The system determines pulse's TOA (Time of Arrival) from the badge to the receiver array, and calculates the 3D positions of the badge based on trilateration or multilateration algorithm.

The structural block diagram of such US positioning system as the “Bat” system is shown in FIG. 1B. A US tag device 101 is attached on the object to be located, which contains a US transmitter. A US positioning device 102 installed on the ceiling includes a plurality of US receivers. A US positioning unit in the US positioning device 102 can collect more than 3 TOA results from different transmitters and then infer the object's position by using multilateration or triangulation method. The calculated position of the object can then be stored in a US result memory.

In another article to P. Bahl. etc. entitled “An In-Building RF-based User Location and Tracking System” (In Proc. IEEE INFOCOM, 2000), it is provided a “RADAR” system for positioning an object based on received signal strength of 802.11 wireless network. The basic RADAR location method is performed in two phases. First, in an off-line phase, the system is calibrated and a RF model is constructed, which indicates received signal strengths at a finite number of locations distributed in the target area. Second, during on-line operation in the target area, mobile units report the signal strengths received from each base station and the system determines the best match between the on-line observations and any point in the on-line model. The location of the best matching point is reported as the location estimate.

Moreover, in U.S. Pat. No. 6,216,087 to R. Want entitled “Infrared Beacon Position System”, it is provided a infrared based location system, called “Active badge” system. The system is built over bidirectional infrared link where one infrared beacon is deployed in each room and the mobile unit is a small, lightweight infrared transceiver that broadcast an unique ID every a fixed interval. Since infrared signals can hardly penetrate walls, ID broadcasts are easily contained within an office, providing highly accurate localization at room granularity.

The above-mentioned patent and non-patent documents are combined in their entireties herein by reference for any purpose.

The following Table. 1 shows a detailed comparison between the three signals when used for indoor location applications, i.e. ultrasound signal, radio frequency signal and infrared signal. For purposes of convenience, to make the comparison, we selected the current representative systems for the three signals respectively, i.e., “Active Badge” for Infrared, “RADAR” for RF and “Bat” for Ultrasound.

TABLE 1
Comparison of Current Location Techniques

| | Infrared (Active | | |
|---|---|---|---|
| | Badge) | RF (Radar) | Ultrasound (Bat) |
| Accuracy | Room- | 3~6 m | 3~5 cm |
| | granularity | | |
| Location | Proximity | RSSI Model | TOA based |
| Strategy | | | Triangulation |
| Working | 20 M~45 MHz | 433 M, 915 M, | 40 KHz |
| Frequency | | 2.4 GHz | |
| Cost | Low | Medium | Expensive |

From the Table.1 we can basically conclude that infrared based location systems is rarely used due to low accuracy and vulnerability to natural light; and that RF systems which use signal strength to estimate location can not yield satisfactory results because RF propagation within buildings deviates heavily from empirical mathematical models.

Regarding US-based Bat system, it is awkward to deploy such a networked system into practical scenario, needing high installation and maintenance costs. In particular, since at least three distance samples are needed to estimate the object's position, very dense ultrasound sensors need to be deployed into building so that system cost is high. On the other hand, Although US positioning approach can achieve highly accuracy, high density of US positioning devices will cause high deployment cost. Especially, it is not necessary to deploy US positioning device at general area where a meter-level location resolution is good enough.

In summary, any existing positioning methods as described above cannot work cost-effectively to achieve high-precision and high-efficiency positioning in an environment where different positioning resolution is required at different regions.

### SUMMARY OF THE INVENTION

Based on the above analysis, the present invention is made to solve the deficiencies of the existing indoor positioning systems. In particular, the present invention provides a hybrid indoor positioning system (HIPS) that incorporates high-precision positioning device (e.g. US sensor) for high-precision localization and low-precision positioning device (e.g. RF sensor) for low-precision localization to provide adaptive positioning resolution for location based services.

In the present invention, the application scenario is divided into two kinds of regions: “Hot Area” where highly accurate positioning is required (for example, in centimeter level), and “General Area” where low positioning accuracy is acceptable (in meters or room level). As an example, ultrasonic positioning device (i.e. US positioning device) is deployed in “Hot Area” for highly accurate localization and RF positioning device is deployed in “General Area” for larger resolution localization. In addition, an online training algorithm is proposed in the present invention, in which the RF model (i.e. RF radio map) can be trained from the real-time position results from the US positioning device. In more details, in the area that can be covered by the US positioning device, i.e. the Hot Area, the more accurate US positioning results can be used to label the RF signal strength (RSS) data, while in the general area, the RSS data will not be labeled because the area cannot be covered by the US positioning device. Then, a semi-supervised learning algorithm can be conducted to train the RF radio map by using the labeled and unlabeled RSS data in real time. In this way, the human calibration efforts for the hybrid positioning system can be reduced.

Moreover, according to the present invention, the setting of the “Hot Area” can be based on the user's requirement or heuristic rules (for example, for a desk or a room etc.). In an embodiment, it is also disclosed that the tracking result of the tag can be used to adjust the position of the US positioning device so that the Hot Area can be covered by the sensing range of the RF positioning device.

According to the first aspect of the present invention, it is provided a method for positioning object with adaptive resolution, comprising: dividing a space to be detected into Hot Area and General Area; arranging, according to the positions of Hot Area and General Area, high-resolution positioning signal transceivers and low-resolution positioning signal transceivers, wherein the detection scope of the low-resolution positioning signal transceivers covers the space and the detection scope of the high-resolution positioning signal transceivers covers the Hot Area; and when the object moving in the space, fusing the detection results from the high-resolution positioning signal transceivers and the low-resolution positioning signal transceivers to determine the position of the object with adaptive resolution.

According to the second aspect of the present invention, it is provided a system for positioning object with adaptive resolution, comprising: a tag device carried by the object for transmitting high-resolution positioning signal (e.g. US signal) and low-resolution positioning signal (e.g. RF signal); a high-resolution positioning apparatus including high-resolution positioning signal transceivers for transmitting and receiving the high-resolution positioning signal; a low-resolution positioning apparatus including low-resolution positioning signal transceivers for transmitting and receiving the low-resolution positioning signal; and a results processing device for fusing the detection results from the high-resolution positioning apparatus and the low-resolution positioning apparatus to determine the position of the object with adaptive resolution, wherein the space to be detected is divided into Hot Area and a General Area, the detection scope of the low-resolution positioning apparatus covers the space, and the detection scope of the high-resolution positioning apparatus covers the Hot Area. As an example, the results processing device can be located locally or remotely in a location server.

As described below in more details, the hybrid indoor positioning system of the present invention can provide adaptive positioning resolution in an environment where different positioning resolutions (precisions or granularities) are required at different regions. Compared with the existing prior arts, the advantages of the present invention are mainly as follow:

Adaptive positioning resolution: based on a positioning fusing method, the system of the present invention can provide different positioning resolutions at different regions.

Low system cost: the deployment cost of the system can be reduced considerably since dense US positioning devices are not needed.

Calibration-less: benefiting from the US positioning device arranged in the Hot Area, the RF module can be trained on-line, so the system needs less human calibration.

Easier area division strategy: based on the user requirement or heuristic rules, it is easy to define the Hot Area. Also, the Hot Area can be accurately covered by adjusting the US positioning system.

### BRIEF DESCRIPTIONS OF THE DRAWINGS

The foregoing and other features of this invention may be more fully understood from the following description, when read together with the accompanying drawings in which:

FIG. 1A is a schematic diagram for showing a US positioning system according to the prior art;

FIG. 1B is an internal block diagram for showing the US positioning system shown in FIG. 1A;

FIG. 2A a schematic diagram for showing a hybrid positioning system according to the present invention;

FIG. 2B is an internal block diagram for showing the hybrid positioning system shown in FIG. 1A according to the first embodiment of the present invention;

FIG. 3 is a flow chart for showing a method 300 for positioning object with adaptive resolution according to the present invention;

FIG. 4 is a schematic diagram for showing the environment to be detected, which is arranged according to the method shown in FIG. 3, wherein the Hot Area is shown for example as a secure desk;

FIG. 5 is a flow chart for showing an object positioning method 500 which includes a Hot Area modification step;

FIG. 6 is a schematic diagram for showing the process of the Hot Area modification;

FIG. 7 shows a block diagram of a positioning system according to the second embodiment of the present invention which conducts RF module (radio map) training by using a semi-supervised learning algorithm;

FIG. 8 is a flow chart for showing the RF radio map training;

FIG. 9 is a schematic diagram for showing the RF radio map training;

FIG. 10 is a block diagram for showing the content results of the radio map generation device; and

FIG. 11 is an internal block diagram for showing a hybrid positioning system by combining the first and the second embodiments of the present invention, which can be used for modifying the RF radio map in a real-time manner while positioning the object.

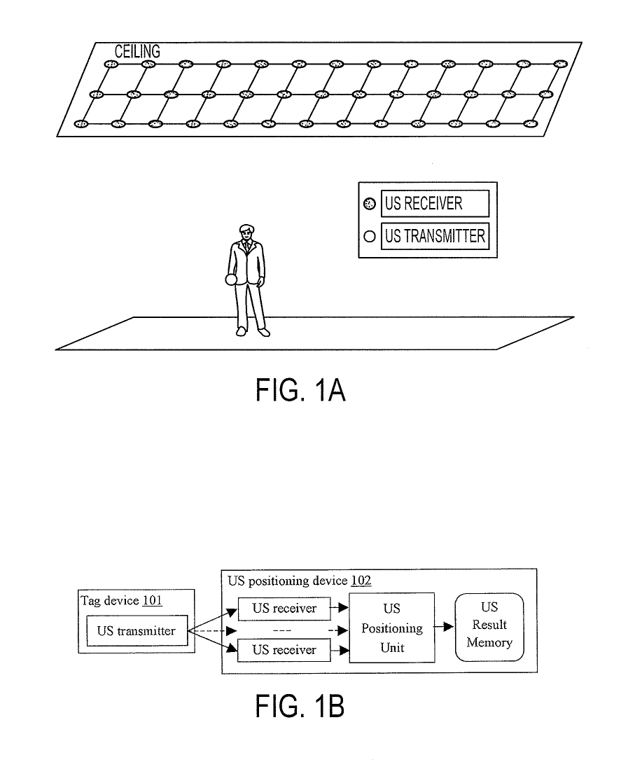

### DETAILED DESCRIPTION OF THE PREFERRED EMBODIMENTS

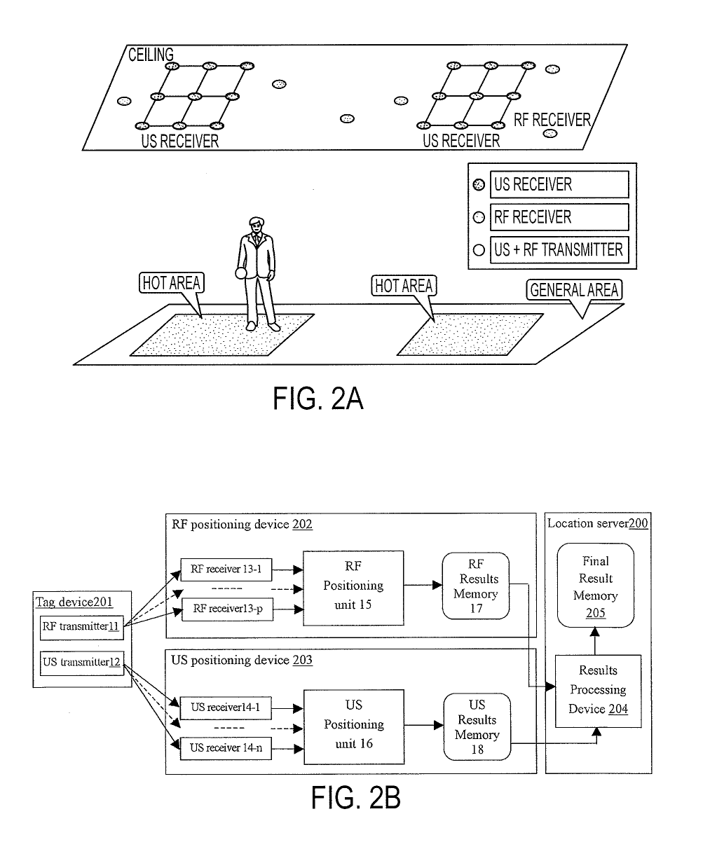

FIG. 2A shows a hybrid positioning system according to the present invention, which can provide adaptive positioning resolution for location based services. The space to be detected is divided into two kinds of areas: “Hot Area” and “General Area”. In the “Hot Area”, highly accurate positioning (for example, in centimeter level) is required, while in the “General Area”, low positioning accuracy (in meters or room level) is acceptable. Ultrasonic (US) receivers are deployed over the “Hot Area” for highly accurate localization and RF receivers are deployed over the whole detected space (either of the “Hot Area” and the “General Area”) for larger resolution localization.

When designing hybrid positioning system of the present invention, the following two aspects are considered:

1. From the application aspect, in location-based access control, it is usually the case that people may require different positioning granularities at different areas. For example, at the interested area, fine-grained positioning granularity is needed so as to make sure that the positioning results for this area are highly accurate. At the other areas, a coarser-grained positioning granularity may be acceptable. In this case, using either RF or ultrasound for positioning is not reasonable. On one hand, the RF positioning is limited in positioning granularity; generally, it can only reach a resolution of meter level. This may not be acceptable for those interested areas with high granularity requirement. On the other hand, although the ultrasound positioning has a high resolution of centimeter level in positioning, the ultrasound sensors are limited in signal coverage and also more expensive than RF sensors. Therefore, directly employing multiple ultrasound receivers for covering a large area is not economical. This motivates the inventors to consider incorporating both ultrasound and RF positioning technologies in providing hybrid positioning granularities.

2. From the technical aspect, ultrasound positioning and RF positioning can benefit from each other. The ultrasound positioning is highly accurate, but is limited by the ultrasound signal's transmission range. Generally, the ultrasound signal can propagate in less than 10 meters; and it is easy to be blocked by the obstacles, which is always the case in indoor office environments. The RF positioning is less accurate, and generally model training methods are exploited to improve the positioning accuracy. And, this model training process often requires many calibration efforts. On the other hand, the advantage of RF signals is that it has larger transmission range, e.g. 30-40 meters in indoor environments, and can penetrate the obstacles such as walls. We will further show that the present invention can utilize both of the ultrasound and RF signals and avoid their disadvantages by providing a calibration-less solution.

FIG. 2B is a block diagram for showing the internal structure of the hybrid positioning system of the present invention. As shown, the tag device 201 carried on the object includes a RF transmitter 11 and a US transmitter 12, which respectively emit RF signals and ultrasound signals. The RF positioning device 202 comprises a plurality of RF receivers 13-1, 13-2, . . . 13-m for receiving RF signals. As described above, these RF receivers can be arranged dispersedly in the whole space to be detected. The RF signals received by the RF receivers can then be sent to the RF positioning unit 15 for obtaining corresponding RF positioning results (e.g. RF signal strength (RSS) vector) by using any existing RF positioning method. As known by those skilled in the art, the existing RF positioning method can be classified into mainly two categories. One is RSS matching algorithm based on RF module such as radio map. The other is to infer the distance between the object and the RF receivers by using the RSS results and then calculate the position of the object with the trilateration method. It is obvious that all of these RF positioning methods can be similarly applied to the present invention for conducting low-precision positioning with respect to the General Area. In the following description, by taking the radio map-based method as an example, it will describe an on-line RF module (e.g. radio map) training method by using a semi-supervised learning algorithm, as a part of the inventive points of the present invention. For more details, please refer to the following corresponding description with respect to FIGS. 7-9. The RF positioning result (e.g. RSS vector) can then be stored in the RF result memory 17. Similarly, the US positioning device 203 includes a plurality of US receivers 14-1, 14-2, . . . 14-n for receiving US signals. As described above, these US receivers can be arranged densely over the Hot Area. US signals received by the US receivers are sent to the US positioning unit 16 for obtaining the corresponding US positioning results (e.g. TOA vectors). The US positioning results (e.g. TOA vectors) can be stored in the US result memory 18. The RF and US positioning results stored in the RF result memory 17 and the US result memory 18 can be fused at the results processing device 204 to determine the position of the object. The finally determined position of the object can be stored in the final result memory 205. As an example, as shown in FIG. 2B, both of the results processing device 204 and the final result memory 205 can be configured in a location server 200. In an embodiment, the results processing device 204 can decide the positioning strategy according to the number of elements in the TOA vector. If there are more than 3 TOA samples, the position of the object can be determined directly from the TOA results by using multilateration or triangulation method. If the number of TOA samples is less than 3, RF result (e.g. RSS vector) needs to be referred to conduct positioning. For example, the position of the object can be determined by searching the RF radio map.

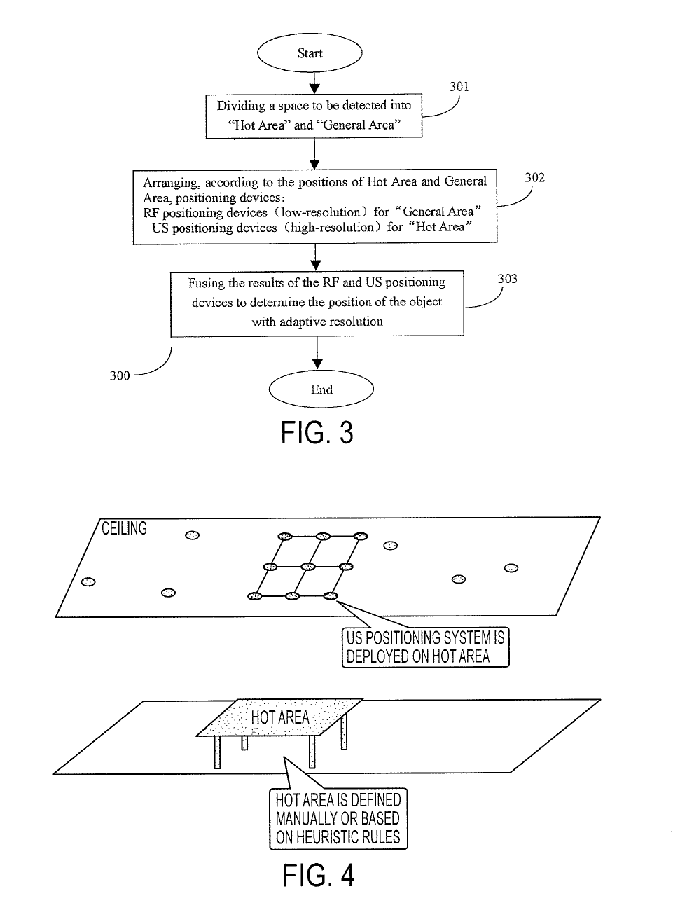

FIG. 3 is a flow chart for showing the object positioning method 300 according to the present invention. The object positioning method 300 according to the present invention includes two phases: Setting-up Phase (steps 301 and 302) and Localization Phase (step 303).

In the setting-up phase, first, in the step 301, the space to be detected is divided into “Hot Area” and “General Area”. The strategy for dividing the areas can be based on the user's requirement or according to some heuristic rules. Then, in the step 302, according to the divided “Hot Area” and “General Area”, positioning devices need to be arranged. In an embodiment, for the “Hot Area” which requires high-precision positioning, relatively dense US receivers are arranged, while for the “General Area” which can accept larger resolution localization, it can be arranged with RF, infrared or Wifi receivers. These receivers can provide advantages such as the scale is relatively large and the deployment cost is relatively low.

In the localization phase (step 303), when the object with the tag device is moving in the space to be detected, if it is in the Hot Area which can be covered by ultrasound, its position can be determined by US positioning device because US positioning can usually achieve higher positioning resolution than RF positioning. If the object moves to outside of the Hot Area, the position of the object can be determined by searching a trained RF radio map.

FIG. 4 shows an example of the division of the space to be detected. In this example, secure desks are defined as “Hot Area”, while other spaces are defined as “General Area”.

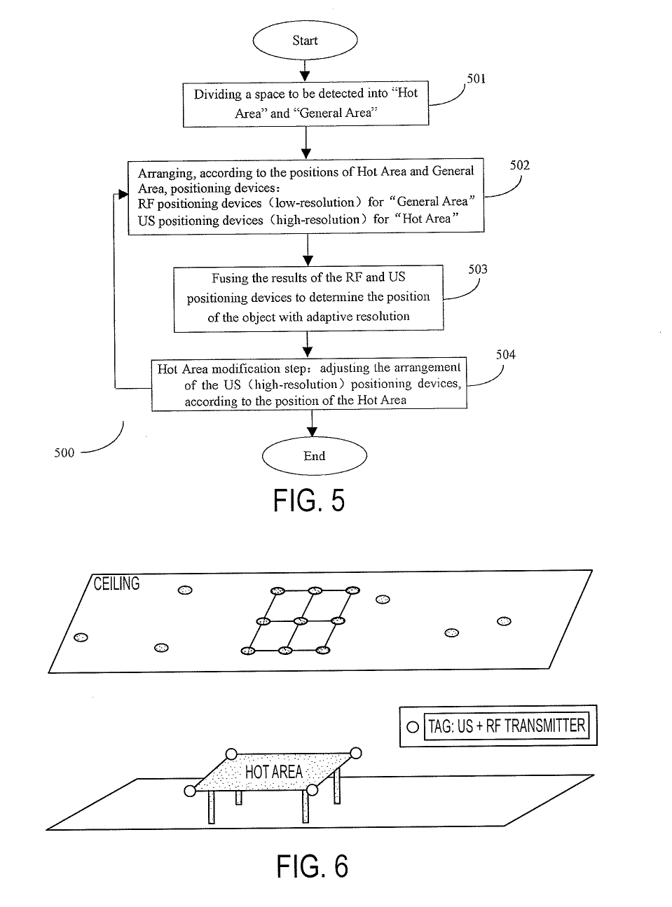

FIG. 5 shows a flow chart for modifying the Hot Area by tracking the pre-installed monitoring tags. In the process, whether the Hot Area is covered by the sensing range of the US positioning device can be monitored in real time. FIG. 6 is to further explain the modification of the Hot Area by using secure desk as an example.

In the FIG. 6, a secure desk is viewed as the “Hot Area”. Four monitoring tags are arranged at the four corners of the secure desk and can emit ultrasound signals. The US receivers contained in the US positioning device can detect the ultrasound signals from the monitoring tags at a pre-set timing (or randomly), and adjust the positions of the US receivers according to the detection results, so that the Hot Area can be guaranteed being covered by the sensing range of the US positioning device.

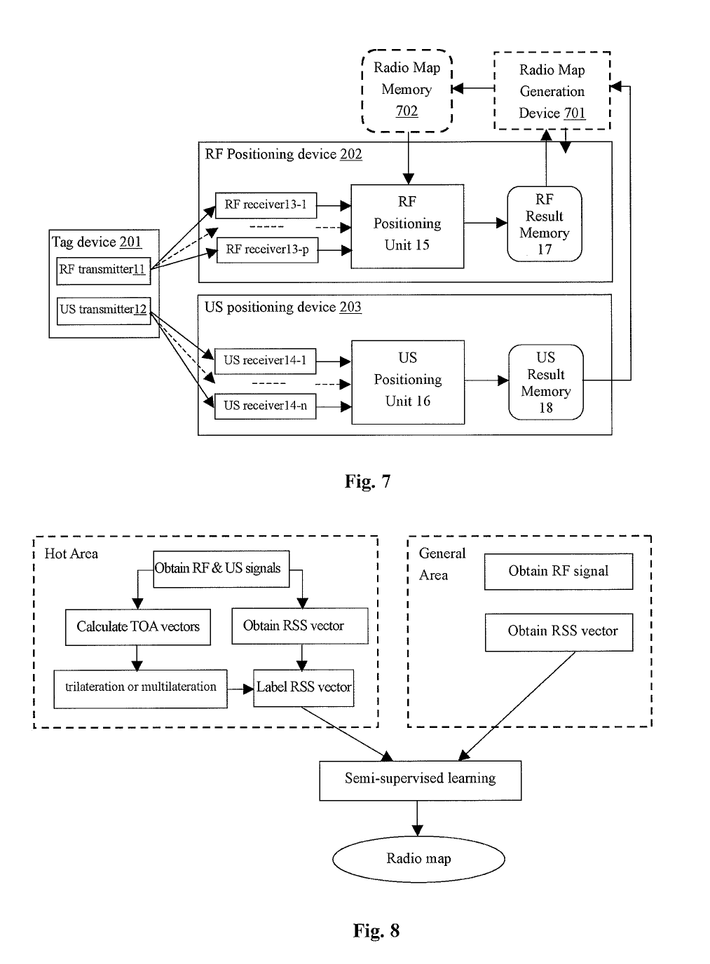

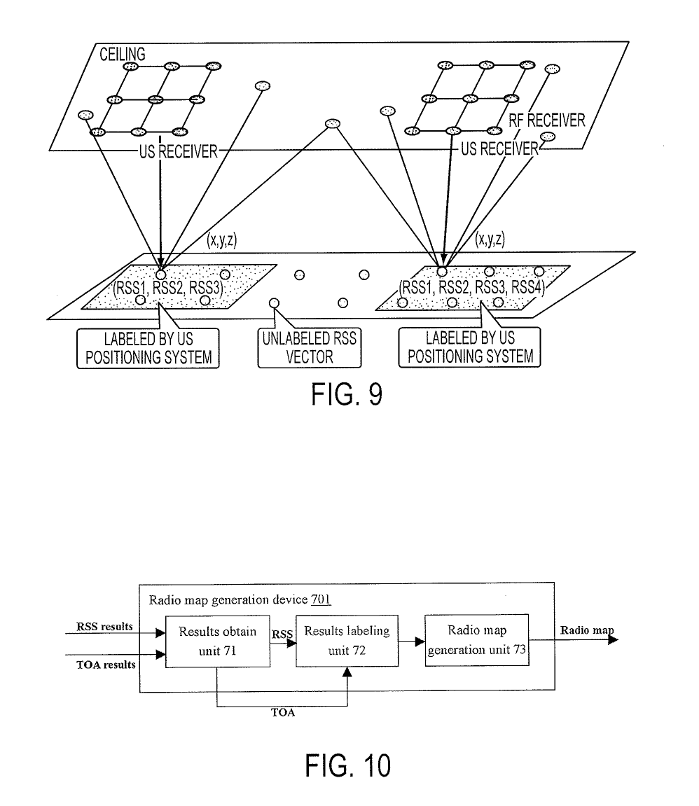

FIG. 7 shows a structural block diagram of the hybrid positioning system according to the second embodiment of the present invention, in which the RF radio map is trained on-line with a semi-supervised learning algorithm. FIG. 8 is a flow chart for showing the RF radio map training, and FIG. 9 is a schematic diagram for showing the RF radio map training. Besides the basic components of the hybrid positioning system as described above, the system shown in FIG. 7 also includes a radio map generation device 701 and a radio map memory 702. The radio map generation device 701 can obtain the positioning results from the RF and US positioning devices and train the RF radio map by using a semi-supervised learning algorithm. When the object is in the General Area, the RF radio map can be used as a reference to conduct RF positioning.

Generally, the user can carry the tag device and move in the detected environment. Since the tag device can emit both of the ultrasound and RF signals simultaneously, both of the two signals correspond to the same position. Assume that there are n US receivers and p RF receivers. Each time when the US transmitter and the RF transmitter of the tag device emit US and RF signals, the US and RF receivers can obtain for example the following result vector:

$${[ {toa}_{1} , {toa}_{2} , … , {toa}_{m} , {rss}_{1} , {rss}_{2} , … {rss}_{q} ]}_{\underbrace{Acquired by US receivers} \underbrace{Acquired by RF receivers}} \qquad ( 1 )$$

wherein toaᵢ (1≦i≦n) represents TOA distance information received by the ith US receiver, m is the number of US receivers which have successfully detected the TOA results, and rssⱼ (1≦j≦p) represents RSS information received by the jth RF receiver, q is the number of RF receivers which have successfully detected the RSS results. Please be noted that m≦n for the reason that there may be some barriers that prevent some of the US receivers from detecting the US signal, and q≦p for the reason that the RSS results from some RF receivers may be too weak and can be ignored.

With reference to the flow chart shown in FIG. 8 and the schematic diagram shown in FIG. 9, in the “Hot Area” covered by the ultrasound, the object can be positioned by the US positioning device. For the RF signal, the RF signal strength (RSS) samples at the respective RF receivers can form a RSS vector. When some of the RSS vectors are collected in the Hot Area, these RSS vectors can be labelled with the position detected by the TOA positioning device. Also, some RSS vectors which are collected at some predetermined landmark positions (e.g. corners of the room) can also be labelled with the corresponding predetermined position coordinates. Of course, this part of vectors should be very few in order to save human calibration effort. The rest of RSS vectors are unlabeled, if they are collected outside the ultrasound coverage area (e.g. in the General Area). Therefore, as shown in FIG. 9, we can have both the labeled and unlabeled RSS data.

Next, as shown in FIG. 8, the labeled and unlabeled RSS vectors are used for training of the RF radio map by using a semi-supervised learning algorithm. The semi-supervised learning algorithm is a class of machine learning techniques that make use of both labeled and unlabeled data for training—typically a small amount of labeled data with a large amount of unlabeled data. Since the semi-supervised learning algorithm is well-known by those skilled in the art, it will not be described in details here. Since the RSS vectors can be labeled by the US positioning system, the RF radio map can be trained in an on-line manner.

The RF radio map after training can be used for positioning of the object during the localization phase. In an embodiment, the position of the object can be estimated based for example on the following fusing strategy:

if m≧3, only [toaₗ, toa₂, . . . , toaₘ] vector is utilized by trilateration or multilateration algorithm for highly accurate positioning.

If m<3, only [rssᵢ, rss₂, . . . , rss_{q}] vector is utilized to search the RF radio map trained by an offline learning algorithm. The positioning accuracy achieved by this method is relatively low. But for the General Area which does not require high-precision positioning, it is acceptable.

FIG. 10 shows the internal structure of the radio map generation device 701. With reference to the flow chart shown in FIG. 8 and the schematic diagram shown in FIG. 9, the radio map generation device 701 acquires through the results obtain unit 71 the low-precision positioning result (e.g. RSS vector) and the high-precision positioning result (e.g. TOA vector) provided respectively by the RF positioning device and the US positioning device. Then, at the results labeling unit 72, if the object is in the Hot Area, the RSS results can be labeled by the TOA results obtained by the US positioning device. The labeled and unlabeled RSS results are both provided to the radio map generation unit 73. At the radio map generation unit 73, the radio map is generated by the semi-supervised learning algorithm.

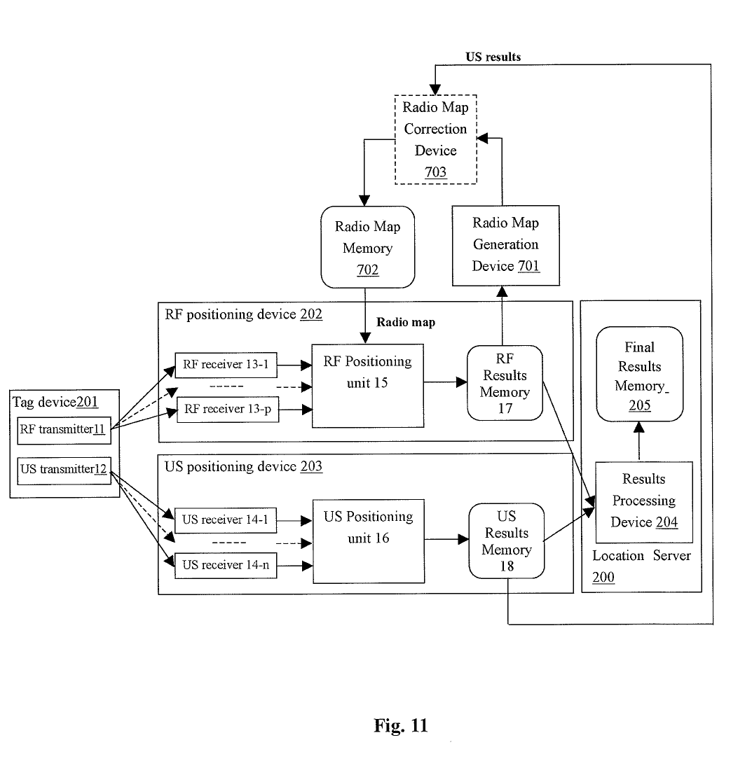

Finally, FIG. 11 is a block diagram for showing an internal structure of a hybrid positioning system which combines the first and second embodiments of the present invention. In the system shown in FIG. 11, it also includes a radio map correction device 703 for modifying the RF radio map in a real-time manner while calculating the position of the object. That is, by referring to the position measurement results of the US positioning device in real time, the contents of the RF radio map can be modified or calibrated.

From the foregoing description, the hybrid positioning system according to the present invention and the method for positioning an object with adaptive resolution by using the hybrid positioning system has been explained in details with reference to the accompanying drawings. According to the above description, it can be seen that the present invention can bring the following beneficial effects:

Based on the positioning fusion algorithm, the system according to the present invention can provide adaptive positioning resolution in different application areas. Also, since it is not necessary to arrange dense array of US receivers to cover the whole application environment, the system cost can be reduced. Moreover, because of the US positioning device arranged in the Hot Area, the RF module (radio map) can be trained on-line. So the system needs less calibration. In the present invention, based on the user's requirement or heuristic rules, it is easy to divide the Hot Area and the General Area, and it is also easy to adjust the US positioning system to better and more accurately cover the Hot Area.

In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for positioning object with adaptive resolution, comprising:
dividing a space to be detected into Hot Area and General Area;
arranging, according to the positions of Hot Area and General Area, high-resolution positioning signal transceivers and low-resolution positioning signal transceivers, wherein the detection scope of the low-resolution positioning signal transceivers covers the space and the detection scope of the high-resolution positioning signal transceivers covers the Hot Area; and
when the object moving in the space, fusing the detection results from the high-resolution positioning signal transceivers and the low-resolution positioning signal transceivers to determine the position of the object with adaptive resolution.

2. The method according to claim 1, wherein the object is capable of transmitting the high-resolution positioning signal and the low-resolution positioning signal.

3. The method according to claim 1, further comprising:
generating a radio map as positioning reference when performing low-resolution positioning.

4. The method according to claim 3, wherein the radio map is generated by using a semi-supervised learning method by steps of:
obtaining detection results for low-resolution positioning signals and high-resolution positioning signals from a plurality of positions in the space to be detected;
when a position is located in the Hot Area, labeling the detection results for low-resolution positioning signals from the position with the corresponding detection results for high-resolution positioning signals; and
generating the radio map based on the labeled and unlabeled detection results for low-resolution positioning signals.

5. The method according to claim 3, wherein the step of determining the position of the object comprises:
determining the position of the object according to the detection results of the high-resolution positioning signal transceivers when the object is located in the Hot Area; and
determining the position of the object by searching the radio map with the detection results of the low-resolution positioning signal transceivers when the object is located in the General Area.

6. The method according to claim 3, wherein during the process of determining the position of the object, the radio map is corrected according to high-resolution positioning results.

7. The method according to claim 1, further comprising a Hot Area modification step for adjusting the positions of the high-resolution positioning signal transceivers to make sure that the Hot Area is covered by the detection scope of the high-resolution positioning signal transceivers.

8. The method according to claim 7, wherein the Hot Area modification step comprises:
placing, on the edge of the Hot Area, a plurality of monitoring devices capable of transmitting high-resolution positioning signals;
receiving the high-resolution positioning signals from the monitoring devices by the high-resolution positioning signal transceivers; and
adjusting the positions of the high-resolution positioning signal transceivers according to the received high-resolution positioning signals to make sure that the Hot Area is covered by the detection scope of the high-resolution positioning signal transceivers.

9. The method according to claim 2, wherein the high-resolution positioning signal is ultrasound or sound signal.

10. The method according to claim 2, wherein the low-resolution positioning signal is radio frequency, infrared or Wifi signal.

11. The method according to claim 9, wherein the plurality of high-resolution positioning signal transceivers receive the high-resolution positioning signals from the object to generate a Time-of-Arrival vector, and the step of determining the position of the object comprises:
calculating the position of the object according to the Time-of-Arrival vector if the number of elements included in the Time-of-Arrival vector is more than or equal to 3; and
determining the position of the object by searching the radio map if the number of elements included in the Time-of-Arrival vector is less than 3.

12. The method according to claim 11, wherein when the number of elements included in the Time-of-Arrival vector is more than or equal to 3, a trilateration or multilateration algorithm is used to calculate the position of the object.

13. A system for positioning object with adaptive resolution, comprising:
a tag device carried by the object for transmitting high-resolution positioning signal and low-resolution positioning signal;
a high-resolution positioning apparatus including high-resolution positioning signal transceivers for transmitting and receiving the high-resolution positioning signal;
a low-resolution positioning apparatus including low-resolution positioning signal transceivers for transmitting and receiving the low-resolution positioning signal; and
a results processing device for fusing the detection results from the high-resolution positioning apparatus and the low-resolution positioning apparatus to determine the position of the object with adaptive resolution, wherein the space to be detected is divided into Hot Area and a General Area, the detection scope of the low-resolution positioning apparatus covers the space, and the detection scope of the high-resolution positioning apparatus covers the Hot Area.

14. The system according to claim 13, further comprising:
a radio map generating device for generating a radio map as positioning reference for the low-resolution positioning apparatus.

15. The system according to claim 14, wherein the radio map generating device comprises:
a results obtaining unit for obtaining detection results for the high-resolution positioning signals and the low-resolution positioning signals from a plurality of positions in the space to be detected;
a results labeling unit for labeling, when a position is located in the Hot Area, the detection results for low-resolution positioning signals from the position with the corresponding detection results for high-resolution positioning signals; and
a radio map generation unit for using a semi-supervised learning method to generate the radio map based on the labeled and unlabeled detection results for low-resolution positioning signals.

16. The system according to claim 14, wherein the results processing device carries out operations of:
determining the position of the object according to the detection results of the high-resolution positioning signal transceivers in the high-resolution positioning apparatus when the object is located in the Hot Area; and
determining the position of the object by searching the radio map with the detection results of the low-resolution positioning signal transceivers in the low-resolution positioning apparatus when the object is located in the General Area.

17. The system according to claim 14, further comprising:
a radio map correction device for correcting, during the process of determining the position of the object, the radio map according to the detection results of the high-resolution positioning signal transceivers in the high-resolution positioning apparatus.

18. The system according to claim 13, further comprising:
a Hot Area modification device for adjusting the positions of the high-resolution positioning signal transceivers in the high-resolution positioning apparatus to make sure that the Hot Area is covered by the detection scope of the high-resolution positioning signal transceivers.

19. The system according to claim 13, wherein the high-resolution positioning signal is ultrasound or sound signal.

20. The system according to claim 13, wherein the low-resolution positioning signal is radio frequency, infrared or Wifi signal.

21. The system according to claim 13, wherein the results processing device is located in a location server.
